(19) United States
(12) Patent Application Publication
(10) Pub. No.: US 2025/0034769 A1
(43) Pub. Date: Jan. 30, 2025

(54) METHOD FOR MANUFACTURING FILTER EDGE BAND NON-WOVEN FABRIC

(71) Applicant: NAMYANG NONWOVEN FABRIC CO., LTD., Ansan-si, Gyeonggi-do (KR)

(72) Inventors: Young Hyun YOON, Anyang-si, Gyeonggi-do (KR); Heon Byung CHAE, Ansan-si, Gyeonggi-do (KR)

(73) Assignee: NAMYANG NONWOVEN FABRIC CO., LTD., Ansan-si, Gyeonggi-do (KR)

(21) Appl. No.: 18/716,433

(22) PCT Filed: Jul. 19, 2022
(86) PCT No.: PCT/KR2022/010486

§ 371 Date: Jun. 4, 2024

(30) Foreign Application Priority Data
Dec. 30, 2021 (KR) 10-2021-0192049

(51) Int. Cl. D04H 1/488; B01D 46/52; D01F 8/14; D04H 1/435; D04H 1/4382

(52) U.S. Cl. CPC D04H 1/488; B01D 46/523; D01F 8/14; D04H 1/435; D04H 1/43828; D10B 2401/00; D10B 2505/04

(57) ABSTRACT

The present invention relates to a method for manufacturing a filter edge band non-woven fabric, and more specifically, to a method for manufacturing an environmentally-friendly filter edge band non-woven that replaces an environmentally harmful filter edge band treated with a chemical binder resin.

### TECHNICAL FIELD

The present invention relates to a method of manufacturing an edge band non-woven fabric, and more particularly to a method of manufacturing a filter edge band nonwoven fabric which is suitable for an edge band of a filter.

### BACKGROUND ART

In general, a filter includes a filter body and an edge band frame surrounding the filter body. In this case, the filter body, which performs a filtering function, is a filter medium in which a support and a melt-blown material are coupled with each other. The filter body is formed in a bent pleat shape in order to significantly increase a filtering area, leading to a maximization of the filtering function. The edge band frame surrounding the filter body is an important auxiliary element necessarily used to stabilize the morphology of the filter media and mount the filter on an air cleaner or a vehicle air conditioner.

Meanwhile, a conventional filter edge band frame is manufactured by resin-treating a dry non-woven fabric with a chemical binder, and its frequency of use continues to increase with the growing demand for the filter. This binder resin-treated filter edge band frame is used to surround and adhere to the bent filter media to create a filter module.

However, the binder resin-treated edge band frame is manufactured by a costly and complex process in which a resin treatment solution is first prepared, the dry non-woven fabric is immersed in the resin treatment solution, dried, and then heat-treated. Further, resin particles may be separated due to friction in a process of bonding the filter body and the edge band to produce the filter module. In addition, when using the filter, the binder resin particles adhered to the filter may also be separated from the filter to block pores of the filter.

Furthermore, in recent years, there is an increasing demand for an environmentally friendly filter edge band non-woven fabric that substitutes the filter edge band nonwoven fabric resin-treated with the chemical binder, including the growing demand of products that do not use the chemical binder resin from an environmental point of view.

There is therefore a need to manufacture the filter edge band non-woven fabric that does not use the chemical binder resin, but its research is limited.

### DISCLOSURE OF INVENTION

### Technical Problem

Accordingly, the present invention has been made in order to solve the above-described problems occurring in the prior art, and it is an object of the present invention is to provide a method of manufacturing an environmentally-friendly filter edge band non-woven that can substitute a filter edge band non-woven fabric resin-treated with a chemical binder.

### Technical Solution

To achieve the above object, the present invention provides a method of manufacturing a filter edge band non-woven fabric, the method including the steps of: needle-punching sheath-core type thermal bonding composite fibers, each composed of a sheath portion comprising a low-melting-point polyester and a core portion comprising a high-melting-point polyester having a melting point higher than that of the sheath portion to thereby produce a needle-punched non-woven fabric; and heat-treating the produced needle-punched non-woven fabric.

In an embodiment of the present invention, the low-melting-point polyester may have a melting point of 100 to 180° C. or a softening point of 100 to 150° C., and the polyester included in the core portion may have a melting point of 250° C. or more.

In addition, the sheath portion and the core portion of the sheath-core type thermal bonding composite fiber may have a weight ratio of 6.0:4.0 to 4.5:5.5.

In addition, the sheath-core type thermal bonding composite fibers may have an average fiber fineness of 1.5 to 4.0 denier and an average fiber length of 38 to 64 mm.

In addition, the heat-treating step may be performed on the produced needle-punched non-woven fabric through a series of process steps including a net drying process step, a can drying process step, and a calendaring process step.

Further, the present invention provides a filter edge band non-woven fabric as a needle-punched non-woven fabric formed from sheath-core type thermal bonding composite fibers, each composed of a sheath portion comprising a low-melting-point polyester and a core portion comprising a high-melting-point polyester having a melting point higher than that of the sheath portion, such that the needle-punched non-woven fabric is produced by thermally bonding the thermal bonding composite fibers to each other.

In an embodiment of the present invention, the filter edge band non-woven fabric may have a basis weight of 200 to 450 g/m² and a thickness of 0.6 to 1.5 mm.

Further, the filter edge band non-woven fabric may have an air permeability of 20 to 80 ccs.

### Advantageous Effects

The non-woven fabric manufacturing method according to the present invention is very suitable for produce a nonwoven fabric which can be used as a filter edge band that substitutes an environmentally harmful filter edge band resin-treated with the chemical binder. In addition, the filter edge band non-woven fabric according to the present invention is manufactured without the need for the resin treatment with the binder so as to maintains thickness, air permeability, morphological stability, and the like suitable for the filter edge band. Thus, it can be widely applied to the manufacture of a variety of filters by using the filter edge band non-woven fabric as a material for an edge band of the filters.

### BRIEF DESCRIPTION OF THE DRAWINGS

FIG. 1 is a flowchart illustrating a process for producing a needle-punched non-woven fabric in a method of manufacturing a filter edge band non-woven fabric according to an embodiment of the present invention; and

FIG. 2 is a flowchart illustrating a heat treatment process for the produced needle-punched non-woven fabric in a method of manufacturing a filter edge band non-woven fabric according to an embodiment of the present invention.

### BEST MODE FOR CARRYING OUT THE INVENTION

Hereinafter, preferred embodiments of the present invention will be described in detail with reference to the accompanying drawings in order to help fully understand the present invention.

Examples of the present invention may be modified in various different forms, and the scope of the present invention should not be construed as being limited to the below-described examples. These examples are provided to completely describe the invention to one having ordinary skill in the art. In the following description of the present invention, a detailed description of related known functions and configurations incorporated herein will be omitted, if necessary, when it may rather make the subject matter of the present invention unclear.

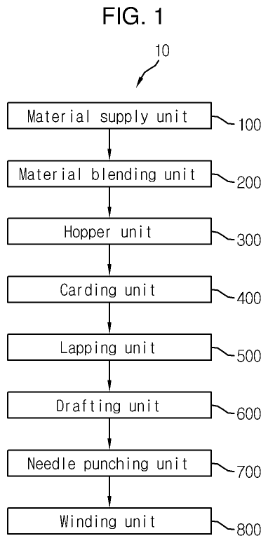

A process 10 of producing a needle-punched non-woven fabric in a method of manufacturing a filter edge band non-woven fabric according to the present invention will be described below with reference to FIG. 1.

Referring to FIG. 1, thermal bonding composite fibers as a yarn forming a non-woven fabric is supplied from a material supply unit 100 to a material blending unit 200, which in turn blends the supplied thermal bonding composite fibers with each other. Then, the thermal bonding composite fibers blended and entangled with each other in the material blending unit 200 are separated in a hopper unit 300. The yarn separated in the hopper unit 300 is formed in the form of a thin film having a uniform thickness in a carding unit 400. Thereafter, a single-layered nonwoven fabric is supplied from the carding unit 400 to a lapping unit 500, which in turn laminates the single-layered nonwoven fabric into multiple layers while laterally moving the single nonwoven fabric layer to thereby form a nonwoven fabric layer with a specific thickness. Then, the nonwoven fabric layer is supplied from the lapping unit 500 to a drafting unit 600 and is stretched. Then, the stretched nonwoven fabric layer is fed from the drafting unit 600 to a needle punched unit 700, and then is bonded by entanglement between fibers by the stroke of the needles in the needle punched unit 700. Subsequently, the nonwoven fabric layer bonded in the needle-punched unit 700 is fed to and wound up in a winding unit 800 to thereby produce a needle-punched non-woven fabric.

The material supply unit 100, the material blending unit 200, the hopper unit 300, the carding unit 400, the lapping unit 500, the needle punching unit 700, and the winding unit 800, which are constituent elements included for the process 10 of producing a needle-punched non-woven fabric according to an embodiment of the present invention and the thermally bonded biodegradable filter support, may adopt a known configuration and function that can be used or appropriately modified in the manufacturing process of the nonwoven fabric, particularly the carding process, and thus a detailed description thereof will be omitted to avoid redundancy.

As such, the use of the nonwoven fabric produced by the carding process enables the creation of a web by spreading a staple fiber as a material thinly, and allows for the manufacture of the needle-punched non-woven fabric by bonding each staple fiber through a physical method using entanglement between fibers by the stroke of the needles. In this case, in order for such a needle-punched nonwoven fabric to effectively function as a filter edge band, it is necessary to implement a needle-punched non-woven fabric having thickness and air permeability capable of maintaining morphological stability of the filter edge band through a heat treatment process.

To this end, in the present invention, the yarn supplied to the material supply unit 100 shown in FIG. 1 uses polyester-based thermal bonding composite fibers, specifically sheath-core type polyester-based thermal bonding composite fibers. A non-woven fabric suitable for the filter edge band is implemented through a series steps of producing a needle-punched non-woven fabric by needle-punching the thermal bonding composite fibers to cause entanglement between the fibers in the needle-punching unit 700, and heat-treating the produced needle-punched non-woven fabric.

First, the sheath-core type polyester-based thermal bonding composite fiber will be described hereinafter.

The thermal bonding composite fiber serves to bond adjacent other thermal bonding fibers when applied with heat and pressure. The thermal bonding composite fiber may be a well-known fiber that is called a low-melting-point yarn (or a low-melting-point fiber), an LM (low melting) yarn, or a non-melting-point yarn (or a non-melting-point fiber) in which a melting point is absent and a softening point is present. The thermal bonding composite fiber may be employed as an appropriate material without limitation as long as it is a polyester-based component having a thermal bonding property, which is employed in the well-known fiber for the above-mentioned use purpose.

A thermal bonding component contained in the thermal bonding composite fibers is manufactured by modifying at least one of the polyhydric carboxylic acid and diol that form polyester to allow the melting point to be lowered or absent, and allow only the softening point to be present. For example, the thermal bonding component may have a melting point of 100 to 180° C. or no melting point, and a softening point of 100 to 150° C. For example, the thermal bonding component may be modified by substituting part of terephthalic acid as an aromatic component of polyhydric carboxylic acid with isophthalic acid, and/or substituting part of the terephthalic acid with aliphatic polyhydric carboxylic acid such as adipic acid. In addition, the thermal bonding component may be modified by substituting part of ethylene glycol as a diol with aliphatic diol such as 1,4-butanediol or 1,6-hexanediol, or branched-chain aliphatic diol such as 2,2-dimethyl-1,3-propanediol or 3-methyl-1,5-pentanediol, but not limited thereto.

In the sheath-core type thermal bonding composite fiber, the thermal bonding component may form the sheath portion thereof, and a component having a melting point higher than that of the thermal bonding component, for example, high-melting-point polyethylene terephthalate may form the core portion thereof.

More preferably, the sheath portion and the core portion of the sheath-core type thermal bonding composite fiber may have a weight ratio of 6:4 to 4.5:5.5. By virtue of this, the sheath-core type thermal bonding composite fiber offers the advantage of having the appropriate thickness and air permeability for the filter edge band and further enhancing morphological stability.

In addition, the sheath-core type thermal bonding composite fibers may have an average fiber length of 38 to 64 mm. It may be preferable to use the thermal bonding composite fiber in order to achieve the object of the present invention.

The needle-punched non-woven fabric according to an embodiment of the present invention produced by using the above-described sheath-core type thermal bonding composite fibers may have an average fiber fineness of 1.5 to 4.0 denier (d). When the above-specified range of the fiber fineness is satisfied, it may be advantageous to achieve the desired levels of thickness, air permeability, morphological stability, and the like, which are intended by the present invention. If the average fiber fineness of the thermal bonding composite fiber is less than 1.5 denier, thickness implementability, strength and morphological stability of the resulting filter edge band non-woven fabric may be lowered, making it difficult to achieve the intended object of the present invention. Furthermore, if the average fiber fineness of the thermal bonding composite fiber exceeds 4.0 denier, it is advantageous in terms of thickness implementability and morphological stability of the resulting filter edge band non-woven fabric, but the increased air permeability decreases hermeticity, which may hinder its effectiveness as the filter edge band.

Subsequently, a heat-treating step is performed on the needle-punched non-woven fabric produced by the above-described method.

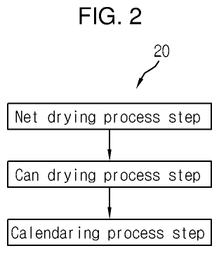

The heat-treating step 20 of the needle-punched non-woven fabric for manufacturing the filter edge band non-woven fabric of the present invention will be described hereinafter with reference to FIG. 2.

The heat-treating step may be performed on the produced needle-punched non-woven fabric through a series of process steps including a net drying process step 210, a can drying process step 220, and a calendaring process step 230 to thereby manufacture the filter edge band non-woven fabric.

The net drying process step 210 is a step of heat-treating the needle-punched non-woven fabric formed from the thermal bonding composite fibers using a net dryer. The thermal bonding composite fibers forming the needle-punched non-woven fabric shrink by the heat treatment with the net dryer to thereby increase the thickness of the non-woven fabric and exhibiting the effect of densifying the structure of the non-woven fabric. For example, the temperature of heat applied to the needle-punched non-woven fabric in the net drying process step may range from 140 to 200° C., and the heat treatment time may range from 1 to 2 minutes. In this case, the temperature and time for the heat treatment with the net dryer may be determined depending on the melting point or the softening point of the sheath portion of the thermal bonding composite fiber. If the melting point or the softening point of the sheath portion of the thermal bonding composite fiber is high, the temperature and time for the heat treatment may increase.

The can drying process step 220 is a step of heat-treating the needle-punched non-woven fabric subjected to the net drying process step using a can dryer. The non-woven fabric heat-treated with the can dryer becomes an ironed non-woven fabric to thereby increase morphological stability and improve surface roughness, and as a result, a non-woven fabric having a structure suitable for the filter edge band may be implemented. For example, the temperature of heat applied to the non-woven fabric in the can drying process step may range from 120 to 180° C., in which case the temperature and time for the heat treatment with the can dryer may be determined depending on the melting point or the softening point of the sheath portion of the thermal bonding composite fiber used. If the melting point or the softening point of the sheath portion of the thermal bonding composite fiber is high, the temperature and time for the heat treatment may increase.

The calendaring process step 230 is a step of calendaring the non-woven fabric subjected to the can drying process step. The calendared non-woven fabric is implemented as a non-woven fabric having a structure suitable for the filter edge band non-woven fabric due to the thermal bonding of the composite fibers forming the nonwoven fabric. This leads to an increase in morphological stability, a densification of the structure of the nonwoven fabric, and a reduction in air permeability. For example, the heat applied in the calendering treatment step may range from 140 to 180° C., in which case the temperature and time for the heat treatment with calendaring may be determined depending on the melting point or the softening point of the sheath portion of the thermal bonding composite fiber used. If the melting point or the softening point of the sheath portion of the thermal bonding composite fiber is high, the temperature and time for the heat treatment may increase.

The heat-treating step according to an embodiment of the present invention is performed through three different heat-treating steps as described above. If any one of the three heat treatment steps is not performed or the order thereof is changed, it may be difficult to achieve a non-woven fabric with thickness, air permeability, morphological stability, and the other properties suitable for the filter edge band.

The filter edge band non-woven fabric manufactured through the aforementioned manufacturing process is a needle-punched non-woven fabric that is formed from sheath-core type thermal bonding composite fibers, each composed of a sheath portion comprising a low-melting-point polyester and a core portion comprising a high-melting-point polyester having a melting point higher than that of the sheath portion such that the needle-punched non-woven fabric is produced by thermally bonding the thermal bonding composite fibers to each other. For example, the filter edge band non-woven fabric may be implemented to have a basis weight of 200 to 450 g/m², preferably 250 to 350 g/m². This is advantageous for implementing the filter edge band non-woven fabric having the physical properties intended by the present invention. If the basis weight is less than 200 g/m², the thickness and strength of the filter edge band non-woven fabric may decrease, resulting in a deterioration of morphological stability and durability. In addition, if the basis weight exceeds 450 g/m², the weight of the filter may increase, resulting in an increase in costs, which may hinder the implementation of the filter edge band non-woven fabric of the present invention.

Further, the filter edge band non-woven fabric according to the present invention may have a thickness of 0.6 to 1.5 mm, preferably 0.9 to 1.2 mm. If the thickness is less than 0.6 mm, thickness implementability and strength of the filter edge band non-woven fabric may decrease, resulting in a deterioration of morphological stability and durability. If the thickness exceeds 1.5 mm, the specific gravity of the filter edge band may increase, resulting in a reduction in the area of the filter fabric that performs the filter function and an increase in costs, which may hinder the implementation of the filter edge band non-woven fabric of the present invention.

The non-woven fabric according to the present invention, manufactured from the aforementioned sheath-core type thermal bonding composite fibers, may have an air permeability of 20 to 80 ccs (cm³/cm²/sec), more preferably 30 to 60 ccs. When the non-woven fabric is applied as the filter edge band non-woven fabric, it is required to ensure hermeticity for blocking the passage of dust particles or air while maintaining morphological stability. If the air permeability exceeds 20 ccs, the hermeticity may be lowered, making it difficult to achieve the desired object of the filter. In addition, if the air permeability is less than 20 ccs, the basis weight and thickness of the filter edge band non-woven fabric may need to increase to achieve the specified range of the air permeability, resulting in a reduction in the area of the aforementioned filter fabric, an increase in the weight of the filter, and thus higher costs.

In addition, the value of a centerline mean roughness (Ra) as the surface roughness of the non-woven fabric may be 30 μm or less, more preferably 25 μm or less. This may prevent damage to the filter media constituting an air filter which is to be supported by the filter edge band non-woven fabric. Further, if the hardness of the non-woven fabric may be 50 or more, more preferably 70 or more. This may be advantageous for maintaining excellent morphological stability, holding the filter media constituting the air filter which is to be supported by the filter edge band non-woven fabric, and preserving the pleated structure of the filter media.

Besides, the present invention includes an air filter assembly consisting of a filter medium bent in a pleat shape and a filter edge band non-woven fabric according to an embodiment of the present invention that surrounds the edge of the filter medium.

The filter media may be a well-known one that can be used in an air filter field. In addition, when the filter medial is bent in the pleat shape, the height of the peaks and the pitch of the valleys of the pleat may be designed in various manners depending on the intended purpose, but the present invention is not particularly limited thereto.

The filter edge band non-woven fabric according to an embodiment of the present is arranged to surround the edge of the filter media. In this case, it may be securely fixed to the edge of the filter media by means of a hot melt adhesive to allow the air filter assembly to be manufactured very easily. Additionally, due to its excellent morphological stability, mechanical strength, thickness, and air permeability, the filter edge band non-woven fabric can stably support the filter media and maintain its morphology.

### EXAMPLES

Hereinafter, the present invention will be described in further detail with reference to examples. It will be obvious to a person having ordinary skill in the art that these examples are for illustrative purpose only and are not to be construed to limit the scope of the present invention.

### Example 1

A needle-punched non-woven fabric having a basis weight of 280 g/m² was prepared using a low melting (LM) yarn from an H company as a thermal bonding composite fiber.

Specifically, the thermal bonding composite fiber is a staple fiber having an average fiber fineness of 4.0 denier (d) and an average fiber length of 51 mm. As the thermal bonding composite fiber, a sheath-core type composite fiber was used which is composed of a sheath portion comprising a low-melting-point polyester (its melting point is 10° C. and its weight average molecular weight is approximately 39,000 g/mol) and a core portion comprising a high-melting-point PET (its melting point is 260° C.), in which the sheath portion and the core portion have a weight ratio of 5:5.

In addition, a needle-punched non-woven fabric was produced from the sheath-core type composite fiber through a material supply unit, a material blending unit, a hopper unit, a carding unit, a lapping unit, a drafting unit, a needle punching unit, and a winding unit, which are sequentially used in a process of producing the needle-punched non-woven fabric as shown in FIG. 1. In this case, the needle-punched non-woven fabric was produced using the needle punching unit composed of six needle punching machines mounted in a needle stroke direction including six downward, upward, downward, upward, downward, and upward directions.

The thus produced needle-punched non-woven fabric was subjected to a heat-treating step consisting of a net drying process step, a can drying process step, and a calendaring process step as shown in FIG. 2 to thereby manufacture a filter edge band non-woven fabric of the present invention. In this case, specifically, the heat-treating step was performed on the produced needle-punched non-woven fabric at a net drying temperature of 160° C., a can drying temperature of 140° C., and a calendaring temperature of 160° C. to thereby manufacture the filter edge band non-woven fabric as shown in Table 1 below.

### Examples 2 to 9

The procedure of Example 1 was repeated, except that the fiber fineness of the thermal bonding composite fiber, the basis weight, thickness, and air permeability of the needle-punched non-woven fabric, and the basis weight, thickness, air permeability, surface roughness, and hardness of the filter edge band non-woven fabric were modified to thereby manufacture the non-woven fabric as shown in Table 1 below.

### Comparative Example 1

A needle-punched non-woven fabric was produced using a general PET fiber having an average fiber fineness of 4.0 denier (d) and an existing filter edge band non-woven fabric manufactured by resin-treating the needle-punched non-woven fabric was used.

### Experimental Example 1

An evaluation was made on the non-woven fabric manufactured in Examples 1 to 9 and Comparative Example 1 in terms of the following physical properties, and the results of the evaluation were shown in Table 1 below.

### 1) Basis Weight

The basis weight of the thus produced needle-punched non-woven fabric and filter edge band non-woven fabric was measured using a standard weighing scale. The non-woven fabric was cut into a size of 50×50 cm at three different points including the center thereof and the left and right intermediate positions based on the center, and the weight of the non-woven fabric was measured at each of these points to obtain an average weight value. The average weight value was then converted to grams per square meter (g/m²) to express the basis weight.

### 2) Thickness

The thickness of the thus manufactured non-woven fabric was measured using a dial thickness gauge (MODEL H, PEACOCK Co., JAPAN). The thickness of the nonwoven fabric was measured at three different points including the center thereof and the left and right intermediate positions based on the center to obtain an average thickness value.

### 3) Air Permeability

The air permeability of the thus manufactured non-woven fabric was measured using an air permeability tester (MODEL FX-3300, TEXTEST Co.). The air permeability of the nonwoven fabric was measured at three different points including the center thereof and the left and right intermediate positions based on the center to obtain an average air permeability value. The measurement of the air permeability was made at a pressure of 125 Pa, and the results of the measurement were expressed in units of ccs (cm³/cm²/sec).

### 4) Surface Roughness

The surface roughness of the thus manufactured non-woven fabric was measured using a small surface roughness tester (MODEL SJ-210, Mitutoyo Co., Ltd.). The surface roughness of the filter edge band nonwoven fabric was measured at three different points including the center thereof and the left and right intermediate positions based on the center to obtain an average surface roughness value. The air permeability was made at a pressure of 125 Pa, and the surface roughness was expressed in units of Ra (μm).

### 5) Hardness

The hardness of the thus manufactured non-woven fabric was measured using a Shore hardness tester (MODEL EX-ASKER C Type, Asker Co., Ltd.). The hardness of the filter edge band nonwoven fabric was measured at three different points including the center thereof and the left and right intermediate positions based on the center to obtain an average hardness value, which was in turn expressed. In this case, since the thickness of at least 6 mm is required by the hardness tester standard, the filter edge band non-woven fabric was ten-layered for hardness measurement.

### 6) Comprehensive Evaluation

The physical properties of the filter edge band non-woven fabric which was manufactured in Examples 1 to 9 and Comparative Examples 1 to 4 were measured and evaluated. As a result of the evaluation of the physical properties, when the filter edge band non-woven fabric satisfy all of the following conditions, it was determined to be acceptable (∘), and all cases other than the following conditions were determined to be unacceptable (x): a thickness of 0.6 to 1.5 mm, a basis weight of 200 to 450 g/m², an air permeability of 20 to 80 ccs, a surface roughness as a centerline mean roughness (Ra) value of 30 μm or less, and a hardness of 50 or more.

TABLE 1

| Thermal | | | | | | | | | |
|---|---|---|---|---|---|---|---|---|---|
| bonding | | | | | | | | | |
| composite | Needle-punched non-woven fabric | | | Filter edge band non-woven fabric | | | | | |
| fiber | basis | | air | basis | | air | surface | | |
| Fiber | weight | thickness | permeability | weight | thickness | permeability | roughness | | Comprehensive |
| fineness (d) | (g/cm²) | (mm) | (ccs) | (g/cm²) | (mm) | (ccs) | (Ra) | hardness | evaluation |
| 4 | 280 | 1.26 | 83 | 326 | 1.18 | 58 | 22 | 78 | ∘ |
| 1.5 | 280 | 1.17 | 65 | 318 | 1.09 | 41 | 19 | 74 | ∘ |
| 2 | 280 | 1.21 | 72 | 314 | 1.14 | 46 | 20 | 76 | ∘ |
| 6 | 280 | 1.35 | 110 | 325 | 1.30 | 96 | 31 | 82 | x |
| 4 | 100 | 0.45 | 280 | 130 | 0.48 | 208 | 25 | — | x |
| 4 | 200 | 0.82 | 154 | 240 | 0.78 | 78 | 24 | 62 | ∘ |
| 4 | 300 | 1.39 | 80 | 352 | 1.24 | 52 | 21 | 80 | ∘ |
| 4 | 350 | 1.43 | 69 | 398 | 1.29 | 46 | 23 | 83 | ∘ |
| 4 | 400 | 1.49 | 69 | 446 | 1.38 | 39 | 24 | 85 | ∘ |
| — | — | — | — | 360 | 1.11 | 51 | 27 | 75 | ∘ |

It could be seen from Table 1 that when the fiber fineness of the thermal bonding composite fibers exceeds 4.0 denier or the basis weight of the filter edge band non-woven fabric is small, air permeability increases, making it unsuitable for the filter edge band non-woven fabric. In addition, in Example 5, the thickness is small, making it impossible to measure the hardness. Further, when compared with Comparative Example 1 in which the needle-punched non-woven fabric was produced using a general PET fiber having an average fiber fineness of 4.0 denier (d) and an existing filter edge band non-woven fabric was manufactured by resin-treating the produced needle-punched non-woven fabric, the physical properties of the filter edge band non-woven fabric manufactured using the thermal bonding composite fibers according to Examples of the present invention showed values similar to those in Comparative Example 1. Furthermore, the filter edge band non-woven fabric manufactured in Examples 1 to 9 showed values similar to or higher than that in Comparative Example 1 in terms of the hardness, which is used as a substitute physical property for morphological stability. Thus, the filter edge band non-woven fabric of Examples 1 to 9 was determined to be favorable in terms of hardness. In particular, the filter edge band non-woven fabric of Examples 1 to 9 showed a favorable result compared to the existing resin-treated edge band non-woven fabric. Resultantly, it could be seen that the filter edge band non-woven fabric of the present invention could be used as a substitute for the existing resin-treated edge band non-woven fabric and exhibited a more excellent effect than that in Comparative Example 1 in terms of some physical properties.

### Experimental Example 2

An air filter assembly for an air purifier was manufactured using each of the filter edge band non-woven fabrics of Example 1, Example 3, and Comparative Example 1. In this case, a filter fabric exhibiting H13 grade performance was used as the filter medium, which was in turn was bent by a conventional method. In addition, the filter edge band non-woven fabric of Example 1 was slit to a width of 35 mm, and used as a filter edge band frame for the filter media, resulting in a filter having a dimension of 340 mm (H)×380 mm (W)×35 mm (D). Then, the filtration efficiency and pressure loss of the filter were evaluated.

The filters were manufactured using the filter edge band non-woven fabrics of Example 1, Example 3, and Comparative Example 1, and the filtration efficiency (%) and pressure loss (mmH₂O) of each filter were measured by the following method in Manufacture Example 1, Manufacture Example 2, and Comparative Manufacture Example 1, respectively, and the results of the measurement were shown in Table 2 below.

### Filtration Efficiency and Pressure Loss

The filtration efficiency (%) and pressure loss (mmH₂O) of each filter were evaluated according to KS C 9325 method. The evaluation was conducted under the following conditions: a wind tunnel length of approximately 8 m, a wind tunnel cross-sectional area of 600 mm×600 mm, and a temperature and humidity condition (25±10° C.), an RH of (55±15) %, and an air blowing amount of 540 m³/h. Additionally, a FLUKE 400 mmH₂O differential pressure gauge (FLUKE, USA), and a GRIMM 11-A particle counter (GRIMM, Germany) were used in the test.

TABLE 2

| | Filter edge | Filter evaluation | |
|---|---|---|---|
| | band non- | Filtration | Pressure loss |
| Classification | woven fabric | efficiency (%) | (mmH₂O) |
| Manufacture | Example 1 | 99.96 | 4.40 |
| Example 1 | | | |
| Manufacture | Example 3 | 99.97 | 4.50 |
| Example 2 | | | |
| Comparative | Comparative | 99.96 | 4.50 |
| Manufacture | Example 1 | | |
| Example 1 | | | |

It could be seen from Table 2 above that the filtration efficiency and pressure loss of the air filter assembly made from the filter edge band non-woven fabrics of Example 1, Example 3, and Comparative Example 1 in Manufacture Example 1 and Manufacture Example 2 were evaluated. The results of the evaluation suggested that the filtration efficiency and pressure loss values of the air filter assemblies in Manufacture Example 1 and Manufacture Example 2 showed favorable values similar to those of the air filter assembly made from the existing resin-treated filter edge band non-woven fabrics of Comparative Example 1 in Comparative Manufacture Example 1. Therefore, it could be confirmed that the filter edge band non-woven fabric of the present invention can effectively replace the existing resin-treated filter edge band non-woven fabric.

Although the embodiments of the present invention have been described above with reference to the accompanying drawings, the present invention is not limited to the above embodiments but may be modified in various forms. It will be understood by those skilled in the art to which the present invention pertains that the present invention may be embodied in other specific forms without departing from the technical spirit or essential characteristics thereof. The presently disclosed embodiments are therefore to be considered in all respects as illustrative and not restrictive.

1. A method of manufacturing a filter edge band non-woven fabric, the method comprising the steps of:
needle-punching sheath-core type thermal bonding composite fibers, each composed of a sheath portion comprising a low-melting-point polyester and a core portion comprising a high-melting-point polyester having a melting point higher than that of the sheath portion to thereby produce a needle-punched non-woven fabric; and
heat-treating the produced needle-punched non-woven fabric.

2. The method according to claim 1, wherein the low-melting-point polyester has a melting point of 100 to 180° C. or a softening point of 100 to 150° C., and the polyester comprised in the core portion has a melting point of 250° C. or more.

3. The method according to claim 1, wherein the sheath portion and the core portion of the sheath-core type thermal bonding composite fiber have a weight ratio of 6.0:4.0 to 4.5:5.5.

4. The method according to claim 1, wherein the sheath-core type thermal bonding composite fibers have an average fiber fineness of 1.5 to 4.0 denier and an average fiber length of 38 to 64 mm.

5. The method according to claim 1, wherein the heat-treating step is performed on the produced needle-punched non-woven fabric through a net drying process step, a can drying process step, and a calendaring process step.

6. A filter edge band non-woven fabric as a needle-punched non-woven fabric that is formed from sheath-core type thermal bonding composite fibers, each composed of a sheath portion comprising a low-melting-point polyester and a core portion comprising a high-melting-point polyester having a melting point higher than that of the sheath portion such that the needle-punched non-woven fabric is produced by thermally bonding the thermal bonding composite fibers to each other.

7. The filter edge band non-woven according to claim 6, wherein the filter edge band non-woven fabric has a basis weight of 200 to 450 g/m² and a thickness of 0.6 to 1.5 mm.

8. The filter edge band non-woven according to claim 6, wherein the filter edge band non-woven fabric has an air permeability of 20 to 80 ccs.
